(19) United States
(12) Patent Application Publication
(10) Pub. No.: US 2022/0081562 A1
(43) Pub. Date: Mar. 17, 2022

(54) HAZE-FREE POLYURETHANE FORMULATIONS

(71) Applicant: Dow Global Technologies LLC, Midland, MI (US)

(72) Inventor: Masayuki Suzuki, Yokohama (JP)

(73) Assignee: Dow Global Technologies LLC, Midland, MI (US)

(21) Appl. No.: 17/424,192

(22) PCT Filed: Jan. 31, 2020
(86) PCT No.: PCT/US2020/016057

§ 371 Date: Jul. 20, 2021

Related U.S. Application Data
(60) Provisional application No. 62/799,110, filed on Jan. 31, 2019.

(51) Int. Cl. C08L 75/08; C08G 18/10; C08G 18/48; C08G 18/32; C08G 18/76; C08G 65/10

(52) U.S. Cl. CPC C08L 75/08; C08G 18/10; C08G 18/48; C08G 2170/00; C08G 18/7621; C08G 65/10; C08L 2201/10; C08G 18/3275

(57) ABSTRACT

Embodiments of the present disclosure are directed to haze-free polyurethane formulations, more particularly, to haze-free polyurethane formulations including tripropylene glycol (TPG) initiator polyol formed in the presence of a double metal cyanide (DMC) catalyst via a continuous process that can be utilized to form haze-free polyurethanes. As an example, a haze-free polyurethane formulation can include a TPG initiator polyol formed in the presence of a DMC catalyst via a continuous process, where the TPG pre-polymer is 30 to 45 percent by weight of the haze-free polyurethane formulation, an organic solvent present from 30 to 60 percent by weight of the haze-free polyurethane formulation, and a polyisocyanate, where the polyurethane formulation has an isocyanate index in a range from 70 to 500.

### FIELD

Embodiments relate to haze-free polyurethane formulations, more particularly, to haze-free polyurethane formulations including a tripropylene glycol (TPG) initiator polyol formed in the presence of a double metal cyanide (DMC) catalyst via continuous process.

### BACKGROUND

Polyurethanes may be used in a variety of applications. Depending upon an application, a particular aesthetic quality and/or mechanical performance of polyurethane may be desired. Polyols are used to form polyurethanes. Polyols include polyether polyols and polyester polyols. For example, polyether polyols may be produced by polymerizing an alkylene oxide. The alkylene oxide can react with one or more functional groups of another material in the presence of a catalyst to form polymer chains. Qualities of the one or more functional group and/or qualities of the catalyst can influence properties such as a molecular weight of a resultant polyether polyol.

As such, with respect to varying properties of polyurethanes depending upon an application thereof, one method is vary a structure and/or a composition of a polyether polyol used in the manufacture of the polyurethane. However, varying a structure and/or a composition of a polyether polyol may have an undesirable impact on other properties (e.g., changing an aesthetic) of the resultant polyurethane. Accordingly, a need exists for polyol compositions that promote desired properties in resultant polyurethanes without undesirably impacting other properties (e.g., an aesthetic) of the resultant polyurethane.

### SUMMARY

Embodiments may be realized by forming a haze-free polyurethane formulation including a haze-free polyurethane formulation including a tripropylene glycol (TPG) initiator polyol formed in the presence of a double metal cyanide (DMC) catalyst via a continuous process, where the TPG initiator polyol is 30 to 45 percent by weight of the haze-free polyurethane formulation, an organic solvent present from 30 to 60 percent by weight of the haze-free polyurethane formulation, and a polyisocyanate, where the polyurethane formulation has an isocyanate index in a range from 70 to 500.

Embodiments may be realized by curing a haze-free polyurethane formulation including a TPG initiator polyol formed in the presence of a DMC catalyst via a continuous process, where the TPG initiator polyol is 30 to 45 percent by weight of the haze-free polyurethane formulation, an organic solvent present from 30 to 60 percent by weight of the haze-free polyurethane formulation, and a polyisocyanate, where the polyurethane formulation has an isocyanate index in a range from 70 to 500.

Embodiments may be realized by preparing a haze-free polyurethane formulation by admixing a polyisocyanate and a TPG initiator polyol formed in the presence of a DMC catalyst via a continuous process, heating and agitating the admixture, adding an organic solvent and a chain extender to form a reaction mixture, and agitating the reaction mixture to form a haze-free polyurethane formulation.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Polyurethanes may be used in a variety of applications. Depending upon an application, a particular aesthetic quality and/or mechanical performance of polyurethane may be desired. For instance, in a packaging application it may be desirable that a polyurethane is haze-free. For example, it may be desirable to produce a haze-free polyurethane adhesive such as those that can be employed to adhere layers of transparent material together and form a resulting haze-free multilayer structure. As used herein, being “haze-free” refers to being transparent under visual inspection by an unaided human eye. For instance, a material or plurality of materials may be from 0.00001 meter to 1 meter thick and be haze-free (transparent through an entire thickness of the material(s)).

As mentioned, properties of polyurethanes can be varied, for instance, by altering a structure and/or a composition of a polyether polyol used in the manufacture of the polyurethane. For instance, changing a type of initiator compound (TPG, MPG, etc.) and/or type of catalyst can alter a structure and/or a composition of a polyether polyol used in the manufacture of the polyurethane, and thus lead to polyurethanes with different properties. Alternatively, or in addition, varying a type of process (e.g., continuous, semi-batch, etc.) of production of a polyether polyol can alter a structure and/or a composition of a polyether polyol, and thus lead to polyurethanes with different properties. For instance, as discussed in U.S. Pat. No. 6,835,801, a TPG starter can be employed in a batch or semi-batch process to prepare a low molecular weight starter compound. Similarly, as discussed in U.S. Pat. No. 9,708,448 butylene oxide can be employed with a TPG starter in the presence of a DMC catalyst to produce butylene oxide polymers having a given functionality.

However, altering a structure and/or a composition of a polyol in vary a property of a polyurethane may have an undesirable impact on other properties of the polyurethane. For instance, Applicant has discovered that various initiator polyols formed via a continuous process in the presence of a DMC catalyst unexpectedly and undesirable lead to hazy polyurethane formulations, as detailed herein. Such hazy polyurethane formulations result in hazy polyurethanes when cured. A hazy polyurethane may be undesirable in various applications such as in various packaging applications seeking to provide a clear/haze-free aesthetic of a material. Advantageously, polyurethane formulations, as detailed herein, including a TPG initiator polyol formed in the presence of a DMC catalyst via a continuous process are haze-free, and when cured provide haze-free polyurethanes, and yet have similar values of other properties (MN, MW, PDI, acid number, OH number, Water %, Unsaturation) as hazy polyurethanes.

As used herein, “polyol” refers to a molecule having an average of greater than 1.0 hydroxyl groups per molecule. As used herein a TPG initiator polyol refers to a partially reacted initiator polyol formed from a polyoxypropylene diol having a nominal functionality of 2.

As used herein, “a,” “an,” “the,” “at least one,” and “one or more” may be used interchangeably unless indicated otherwise. The term “and/or” means one, one or more, or all of the listed items. The recitations of numerical ranges by endpoints include all numbers subsumed within that range, e.g., 1 to 5 includes 1, 1.5, 2, 2.75, 3, 3.80, 4, 5, etc.

In various embodiment the TPG initiator polyol can be from 30 to 45 percent by weight of the haze-free polyurethane formulation. All individual values and subranges from 30 weight percent (wt %) to 45 wt % of a total weight of the haze-free polyurethane formulation are included; for example, the portion of the TPG initiator polyol can be from a lower limit of 30 wt %, 35 wt %, or 40 wt % to an upper limit of 45 wt %, 42 wt %, 40 wt %, or 37 wt % of the total weight of the haze-free polyurethane formulation. For instance, in some embodiments the TPG initiator polyol can be about 42 wt % by weight of the haze-free polyurethane formulation.

In various embodiments the haze-free polyurethane formulation can include an organic solvent such as ethyl acetate or other organic solvent. That is, in some embodiments the haze-free polyurethane formulation can include ethyl acetate as an organic solvent.

In various embodiments the organic solvent can be from 30 to 60 percent by weight of the haze-free polyurethane formulation. All individual values and subranges from 30 weight percent (wt %) to 60 wt % of a total weight of the haze-free polyurethane formulation are included; for example, the portion of the organic solvent can be from a lower limit of 30 wt %, 35 wt %, or 40 wt % to an upper limit of 60 wt %, 50 wt %, or 45 wt % of the total weight of the haze-free polyurethane formulation. For instance, in some embodiments the organic solvent can be about 50 wt % by weight of the haze-free polyurethane formulation.

In some embodiments a ratio between the TPG initiator polyol and the organic solvent is from 0.5:1 to 1.5:1 by weight percent of a total weight percent of the haze-free polyurethane formulation. All individual values and subranges from 0.5:1.0 to 1.5:1.0 are included; for example, the TPG initiator polyol and the organic solvent can be in a ratio from 0.5 to 1.0, 0.6 to 1.0, 0.7 to 1.0, 0.8 to 1.0, 0.9 to 1.0, 1.0 to 1.0, 1.1 to 1.0; 1.2 to 1.0, 1.3 to 1.0, 1.4 to 1.5 or from 1.0:1.0 to 1.5:1.0, among other possible ratios.

The polyol compositions disclosed herein can include an isocyanate. The isocyanate may be a polyisocyanate. As used herein, “polyisocyanate” refers to a molecule having an average of greater than 1.0 isocyanate groups/molecule, e.g. an average functionality of greater than 1.0. That is, in various embodiments, the haze-free polyurethane formulation can include a polyisocyanate.

As mentioned, the isocyanate may have an average functionality of greater than 1.0 isocyanate groups/molecule. For instance, the isocyanate may have an average functionality from 1.75 to 3.50. All individual values and subranges from 1.75 to 3.50 are included; for example, the isocyanate may have an average functionality from a lower limit of 1.75, 1.85, or 1.95 to an upper limit of 3.50, 3.40 or 3.30.

The isocyanate may have an isocyanate equivalent weight 80 g/eq to 300 g/eq. All individual values and subranges from 80 to 300 g/eq are included; for example, the isocyanate may have an isocyanate equivalent weight from a lower limit of 80, 90, 100, 125, 135, or 145 to an upper limit of 300, 290, 285, or 280 g/eq.

The isocyanate may be prepared by a known process. For instance, the polyisocyanate may be prepared by phosgenation of corresponding polyamines with formation of polycarbamoyl chlorides and thermolysis thereof to provide the polyisocyanate and hydrogen chloride, or by a phosgene-free process, such as by reacting the corresponding polyamines with urea and alcohol to give polycarbamates, and thermolysis thereof to give the polyisocyanate and alcohol, for example.

The isocyanate may be obtained commercially. Examples of commercial isocyanates include, but are not limited to, polyisocyanates under the trade name Coronate T100 available from the TOSOH Corporation, among other commercial isocyanates.

In some embodiments the polyisocyanate can be from 1 to 20 percent by weight of the haze-free polyurethane formulation. All individual values and subranges from 1 weight percent (wt %) to 20 wt % of a total weight of the haze-free polyurethane formulation are included; for example, the portion of the polyisocyanate can be from a lower limit of 1 wt %, 5 wt %, or 10 wt % to an upper limit of 20 wt %, or 15 wt %, of the total weight of the haze-free polyurethane formulation. In various embodiments the polyisocyanate can be from 1 to 20 percent by weight of the haze-free polyurethane formulation. For instance, in some embodiments the polyisocyanate can be about 8 wt % by weight of the haze-free polyurethane formulation.

The polyisocyanate can have an isocyanate index in a range from 70 to 500. All individual values and subranges from 70 to 500 are included; for example, isocyanate can be from a lower limit of 70, 85, 100, 120 to an upper limit of 500, 400, 300, 200, 160, or 140 percent by weight of the haze-free polyurethane formulation.

DMC Catalyst

Exemplary double metal cyanide catalysts are discussed in International Publication No. WO 2012/09196. The DMC catalyst, for example, ones that are known in the art, may be used in the sequential method. In particular, the DMC catalyst is the first catalyst that is provided as part of sequential method in which at least a first catalyst and second catalyst after the first catalyst is provided.

For instance, the DMC catalysts may be represented by the Formula 1:

M_{b}[M¹(CN)ᵣ(X)ₜ]_{c}[M²(X)₆]_{d}.nM³ₓA_{y} (Formula 1)

where M and M³ are each metals; M¹ is a transition metal different from M, each X represents a group other than cyanide that coordinates with the M¹ ion; M² is a transition metal; A represents an anion; b, c and d are numbers that reflect an electrostatically neutral complex; r is from 4 to 6; t is from 0 to 2; x and y are integers that balance the charges in the metal salt M³ₓA_{y}, and n is zero or a positive integer. The foregoing formula does not reflect the presence of neutral complexing agents such as t-butanol which are often present in the DMC catalyst complex. M and M³ are each a metal ion independently selected from the group of Zn⁺², Fe⁺², Co⁺², Ni⁺², Mo⁺⁴, Mo⁺⁶, Al⁺³, V⁺⁴, V⁺⁵, Sr⁺², W⁺⁴, W⁺⁶, Mn⁺², Sn⁺², Sn⁺⁴, Pb⁺², Cu⁺², La⁺³ and Cr⁺³, with Zn⁺² being preferred. M¹ and M² are each independently selected from the group of Fe⁺³, Fe⁺², Co⁺³, Co⁺², Cr⁺², Cr⁺³, Mn⁺², Mn⁺³, Ir⁺³, Ni⁺², Rh⁺³, Ru⁺², V⁺⁴, V⁺⁵, Ni²⁺, Pd⁺², and Pt²⁺. According to exemplary embodiments, those in the plus-three oxidation state are more used as the M¹ and M² metal. For instance, Co′ and/or Fe′ may be used.

Exemplary anions can include but are not limited to halides such as chloride, bromide and iodide, nitrate, sulfate, carbonate, cyanide, oxalate, thiocyanate, isocyanate, perchlorate, isothiocyanate, an alkanesulfonate such as methanesulfonate, an arylenesulfonate such as p-toluenesulfonate, trifluoromethanesulfonate (triflate), and a C₁₋₄ carboxylate. For instance, the chloride ion may be used. r is 4, 5 or 6 (e.g., 4 or 6, or 6); t is 0 or 1. In exemplary embodiments, r+t will equal six.

In one or more embodiments, the DMC catalyst is a zinc hexacyanocobaltate catalyst complex. The DMC catalyst may be complexed with t-butanol. The DMC catalyst used in various embodiments may be a blend catalyst that includes one or more DMC catalysts. The blend catalyst may optionally include a non-DMC catalyst, in which the DMC catalysts account for at least 75 wt % of the total weight of the blend catalyst.

Chain Extender

In various embodiments the haze-free polyurethane formulation can include a chain extender. For instance, the chain extender can be selected from a group consisting of diethanol amine, monoethanol amine, triethanol amine, mono(isopropanol) amine, di(isopropanol) amine, tri(isopropanol) amine, glycerine, trimethylol propane, and pentaerythritol. In some embodiments the chain extender can be from 0.1 to 20 percent by weight of the haze-free polyurethane formulation. All individual values and subranges from 0.1 weight percent (wt %) to 20 wt % of a total weight of the haze-free polyurethane formulation are included; for example, the chain extender can be from a lower limit of 0.5 wt %, 1 wt %, 5 wt %, or 10 wt % to an upper limit of 20 wt %, or 15 wt %, of the total weight of the haze-free polyurethane formulation. For instance, in some embodiments the chain extender can be about 0.5 wt % by weight of the haze-free polyurethane formulation.

Initiator Compound

Initiator compounds include but are not limited to monopropylene glycol, dipropylene glycol, tripropylene glycol, water, 1,4-butane diol, 1,6-hexane diol, 1,8-octane diol, cyclohexane dimethanol, glycerin, trimethylolpropane, trimethylolethane, pentaerythritol, sorbitol and sucrose, as well as alkoxylates (especially ethoxylates and/or propoxylates) of any of these that have a hydroxyl equivalent weight less than that of the product of the polymerization (e.g., up to 500 g/mol equivalence).

Polyether Polyol/Starter Compound

The Starter compound is formed using an alkylene oxide such as EO, PO or BO. The Starter compound may be a diol or triol. For instance, the Starter compound can be an all PO based diol. Further, a hydroxyl-containing initiator compound is used with the alkylene oxide to form the Starter compound. The hydroxyl-containing initiator compound is any organic compound that is to be alkoxylated in the polymerization reaction.

In various embodiments, a haze-free polyurethane formulation can be prepared by admixing a polyisocyanate and TPG initiator polyol formed in the presence of a DMC catalyst via a continuous process, heating and agitating the admixture (e.g., heating to a temperature in a range from 50 to 200° C., such as 80° C.), adding an Organic solvent and a Chain extender to form a reaction mixture, and agitating the reaction mixture to form a haze-free polyurethane formulation, as described herein. For instance, the polyether polyol (Starter Compound 1, Starter Compound 2, Starter Compound 3, Starter Compound 4, Starter Compound 5) may be prepared as described herein.

The resultant polyether polyol product of the methods herein may be further treated, for example, in a flashing process and/or stripping process. For instance, the polyether polyol may be treated to reduce catalyst residues even though the catalyst residue may be retained in the product. Moisture may be removed by stripping the polyol.

The polyoxyalkylene polyol, according to embodiments, may have a DMC catalyst concentration (in ppm in the final polyoxyalkylene polyol) of from 15 ppm to 100 ppm (e.g., 35 ppm to 100 ppm, 50 ppm to 75 ppm, about 30 ppm etc.).

One or more embodiments of the present disclosure provide that the haze-free polyurethane compositions may include one or more additional components e.g., additional components known in the art. Examples of additional components include cell compatibilizing agents, additional crosslinkers, toughening agents, flow modifiers, viscosity modifiers, reactivity modifiers, solvents, carriers, adhesion promoters, diluents, stabilizers, plasticizers, catalyst de-activators, flame retardants, inorganic fillers, smoke suppression agents, liquid nucleating agents, solid nucleating agents, Ostwald ripening retardation additives, pigments, colorants, chain extenders, antioxidants, biocide agents, and combinations thereof, among others known in the art. Different additional components and/or different amounts of the additional components may be utilized for various applications.

For instance, the polyoxyalkylene polyol, according to embodiments, may have an additive such as phosphoric acid concentration (in ppm in the final polyoxyalkylene polyol) of from 1.0 to 300 ppm (e.g., 100 ppm to 250 ppm, 8 ppm to 30 ppm, etc.) and/or an antioxidant concentration (in ppm in the final polyoxyalkylene polyol) of from 1 ppm to 5000 ppm (e.g., 100 ppm to 250 ppm, 250 ppm to 750 ppm, 1000 to 5000 ppm, etc.). For instance, in some embodiments the additive concentration can be about 11 ppm and the antioxidant concentration can be about 500 ppm.

In some embodiments, the TPG initiator polyol can have an acid number in a range from 0.01 to 0.20, a hydroxyl (OH) number in a range from 50 to 140; a water percent (%) in a range from 0.010 to 0.050; and an unsaturation in a range from 0.0050 to 0.0100.

As mentioned, the TPG initiator polyol can have an acid number in a range from 0.010 to 0.50. All individual values and subranges from 0.010 to 0.50 are included; for instance, the acid number can be from a lower limit of 0.010 or 0.015 to an upper limit of 0.5, 0.2, or 0.1. In some embodiments the TPG initiator polyol can have a acid number of 0.013.

As mentioned, the TPG initiator polyol can have a OH number in a range from 50 to 140. All individual values and subranges from 50 to 140 are included; for instance, the OH number can be from a lower limit of 50, 75, 100, 110 or 120 to an upper limit of 140 or 130. For instance, in some embodiments the TPG initiator polyol can have a OH number in a range from 50 to 120 or 100 to 115, among other possible ranges. In some embodiments the TPG initiator polyol can have a OH number of about 114 or about 56.

As mentioned, the TPG initiator polyol can have a water % in a range from 0.010 to 0.050. All individual values and subranges from 0.010 to 0.020 are included; for instance, the water % can be from a lower limit of 0.010, 0.012 or 0.014 to an upper limit of 0.050, 0.020, 0.018 or 0.016. For instance, in some embodiments the TPG initiator polyol can have a water % in a range from 0.010 to 0.016 or 0.010 to 0.012, among other possible ranges. In some embodiments the TPG initiator polyol can have a water % of about 0.011. In some embodiments the TPG initiator polyol can have a water % that is less than 0.05.

As mentioned, the TPG initiator polyol can have an unsaturation in a range from 0.0010 to 0.030. All individual values and subranges from 0.0010 to 0.030 are included; for instance, the unsaturation can be from a lower limit of 0.0010, 0.0055 or 0.0060 to an upper limit of 0.030, 0.0090 or 0.0080. For instance, in some embodiments the TPG initiator polyol can have an unsaturation in a range from 0.0050 to 0.0080 or 0.0070 to 0.0080, among other possible ranges. In some embodiments, the TPG initiator polyol can have an unsaturation of less than 0.01. For instance, in some embodiments the TPG initiator polyol can have an unsaturation of about 0.0072.

In various embodiments, a method can include curing the haze-free polyurethane formulations, as described herein, to form a haze-free polyurethane. That is, haze-free polyurethane formulations produced in accordance the methods herein may be useful for making polyurethane formulations, which when cured, can form polyurethanes such as those used in making elastomeric or semi-elastomeric polyurethane products, including noncellular or microcellular elastomers, coatings, adhesives, sealants, and flexible, rigid, and viscoelastic polyurethane foams. In one or more embodiments, a haze-free polyurethane adhesive is formed by curing any one of the haze-free polyurethane formulations. The cured product may be prepared using known methods, equipment, and conditions, which may vary for different applications.

In some embodiments the haze-free polyurethane formulations can have a MN in a range from 800 to 3000, a MW in a range from 800 to 2000, and a polydispersity index (PDI) in a range from 1.0 to 1.5.

As mentioned, the haze-free polyurethane formulations can have a MN in a range from 800 to 3000. All individual values and subranges from 800 to 3000 are included; for instance, a MN can be from a lower limit of 800, 900, or 1000 to an upper limit of 3000, 2400, 2000, 1600, 1200, or 1100. For instance, in some embodiments the haze-free polyurethane formulation can have a MN in a range from 800 to 1200 or 900 to 1100, among other possible ranges. In some embodiments the haze-free polyurethane formulation can have a MN of about 919.

As mentioned, the haze-free polyurethane formulations can have a MW in a range from 800 to 2000. All individual values and subranges from 800 to 2200 are included; for instance, a MW can be from a lower limit of 800, 900, or 1000 to an upper limit of 2200, 2000, 1800, or 1200. For instance, in some embodiments the haze-free polyurethane formulation can have a MW in a range from 800 to 1200, 1000 to 1200, or 1100 to 1200, among other possible ranges. In some embodiments the haze-free polyurethane formulation can have a MW of about 1085.

As mentioned, the haze-free polyurethane formulations can have a PDI in a range from 1.0 to 1.5. All individual values and subranges from 1.0 to 1.5 are included; for instance, the PDI can be from a lower limit of 1.0, 1.05, or 1.15 to an upper limit of 1.5, 1.4, or 1.2. For instance, in some embodiments the haze-free polyurethane formulation can have a PDI in a range from 1.0 to 1.2, or 1.1 to 1.2, among other possible ranges. In some embodiments the haze-free polyurethane formulation can have a PDI of about 1.18.

### Examples

All parts and percentages are by weight unless otherwise indicated.

As used herein, the term “weight average molecular weight (Mw)” generally refers to a molecular weight measurement that depends on the contributions of polymer molecules according to their sizes. As used herein, the term “number average molecular weight (Mn)” generally refers to a molecular weight measurement that is calculated by dividing the total weight of all the polymer molecules in a sample with the total number of polymer molecules in the sample. These terms are well-known by those of ordinary skill in the art.

Analytical Methods:

Weight average molecular weight (Mw) and number average molecular weight (Mn): can be measured using gel permeation chromatography (GPC), also known as size exclusion chromatography (SEC). This technique utilizes an instrument containing columns packed with porous beads, an elution solvent, and detector in order to separate polymer molecules of different sizes. Measurement of molecular weight by SEC is well known in the art and is discussed in more detail in, for example, Slade, P. E. Ed., Polymer Molecular Weights Part II, Marcel Dekker, Inc., NY, (1975) 287-368; Rodriguez, F., Principles of Polymer Systems 3rd ed., Hemisphere Pub. Corp., NY, (1989) 155-160; U.S. Pat. No. 4,540,753; and Verstrate et al., Macromolecules, vol. 21, (1988) 3360; T. Sun et al., Macromolecules, vol. 34, (2001) 6812-6820.

Polydispersity index (PDI): refers to a measure of the distribution of molecular mass in a given polymer sample. The polydispersity index is calculated by dividing the Mw by the Mn.

Hydroxyl Number (OH Number): A number arising from a wet analytical method for the hydroxyl content of a polyol; it is the milligrams of potassium hydroxide equivalent to the hydroxyl content in one gram of polyol or other hydroxyl compound.

$$OH Number = \frac{56.1 \times 1000}{Equivalent Weight} \qquad ( 6.2 )$$

where 56.1 is the atomic weight of potassium hydroxide and 1000 is the number of milligrams in one gram of sample. The OH number for each lot of polyol is provided by the manufacturer.

Polyols are sometimes characterized by quoting the weight percentage of hydroxyl groups. Conversion to hydroxyl number is accomplished by:

OH Number=33×% OH (6.3)

where the number 33 is obtained by reduction of constants. For a mixture of polyols, the hydroxyl number of the mixture (OHm) is given by:

OHₘ=OH Number_{A}(Wt. % Polyol A)+OH Number_{B}(Wt. % Polyol B)+ . . . (6.4)

Equivalent Weight of a Polyol: The weight of a compound per reactive site.

$$Equivalent Weight = \frac{Molecular Weight}{Functionality} \qquad ( 6.5 )$$

Since polyols have a molecular weight distribution, an average equivalent weight is calculated. These calculations are done using the product analyzed hydroxyl (OH) content and acid number:

$$Equivalent Weight = \frac{56.1 \times 1000}{OH Number + acid number} \qquad ( 6.6 )$$

For most polyols in use today, the acid number is very low and may be omitted. If the acid number is larger than about 1.0, it should be factored into the above equation.

Example: The lot analysis for a new batch of polyol indicates a OH Number of 54.2 and an acid number of 0.01. What is the polyol's equivalent weight?

$$\begin{matrix}Equivalent Weight = \frac{56.1 \times 1000}{54.2 + 0.01} & ( 6.7 ) \\ Equivalent Weight = 1035 & ( 6.8 )\end{matrix}$$

Acid number (acid #): A number arising from a wet analytical method to determine the amount of residual acidic material in a polyol. The acid number can be determined by ASTM D-1386, for example, where the acid number refers to an amount of KOH in mg KOH/g polymer required to neutralize acid functionality when measured by titration.

Controlled polymerization ratio (CPR): the CPR is a value that quantitatively defines the weakly basic materials present in a polyol. The reported number is ten times the number of milliliters of 0.01 N HCl necessary to neutralize 30 grams of polyol sample.

Water percent (water %): An amount of water in a free, nonchemically bound state report in units of weight percent of a total weight of a polyurethane formulation or weight percentage of a total weight of an initiator polyol.

Unsaturation: There may be small amounts of allyl- or propenyl-type unsaturation in polyols, such as resulting from propylene oxide isomerization during polyol manufacture. Unsaturation is expressed as the number of milliequivalents per gram (meq/g) of polyol sample. Unsaturation levels are determined by procedure ASTM D 2849-69. Propenyl unsaturation (vinyl ether) is determined by the procedure documented in Quantitative Organic Analysis via Functional Groups by Siggia, 4th edition, ISBN 0-471-03273-5.

The following materials are principally used:

| | |
|---|---|
| Isocyanate | A polyisocyanate formed of 2,4 TDI having an isocyanate |
| | equivalent weight of approximately >95% (available from |
| | TOSOH Corporation as Coronate T100). |
| Initiator compound 1 | A tripropylene glycol (available from Dow as Tripropylene |
| | Glycol Regular Grade). |
| Initiator compound 2 | A monopropylene glycol (available from Dow as Propylene |
| | Glycol Industrial Grade). |
| Initiator compound 3 | A dipropylene glycol (available from Dow as Dipropylene |
| | Glycol Regular Grade). |
| Initiator compound 4 and 5 | A monopropylene glycol (available from Dow as Propylene |
| | Glycol Industrial Grade). |
| Starter Compounds 1-3 | Polyoxypropylene diols having a Mn of approximately |
| | 1000 g/mole that is prepared as described herein. |
| Starter Compound 4 | A polyoxyalkylene diol having a Mn of approximately |
| | 1000 g/mole (available from The Dow Chemical Company |
| | as VORANOL ™ 2110-TB) formed from propylene oxide. |
| Starter Compound 5 | A polyoxyalkylene diol having a Mn of approximately |
| | 1000 g/mole (available from Shandong Dongda Chemical |
| | Industry Co., Ltd. as Dongda DL1000) formed from |
| | propylene oxide. |
| DMC Catalyst | A zinc hexacyanocobaltate catalyst complex (available |
| | from Bayer as Arcol Catalyst). |
| Chain extender | A secondary amine such as diethanol amine (available in a |
| | reagent grade from Kanto Chemical Co., Ltd.) |
| Additive | An acidifying agent such as phosphoric acid (available in a |
| | reagent grade as Phosphoric Acid 85% from Kanto |
| | Chemical Industry Co., Ltd.) |
| Antioxidant | A hindered phenolics such as IRGANOX 1076 available |
| | from BASF. |

Working Example 1 and Comparative Examples A and B are prepared using the above materials prepared in relative amounts as outlined in Table 1, below. Comparative Examples C and D are prepared as described herein using commercially available Starter Compound 4 and Starter Compound 5, respectively.

Referring to Table 1, Initiator Compound, Propylene oxide and DMC catalyst amounts are listed in weight percent while the additive and antioxidant are listed in as parts per million (ppm) by weight of a final polyoxyalkylene polyol (e.g., a PO diol) that has been stripped of moisture. Referring to Table 2, the components of the polyurethane formulations of Working Example 1 are described in weight percentages of a total weight of the polyurethane formulation. As detailed below, Comparative Examples A-D are formed using the same amounts of relative components but with different Starter Compounds (Starter Compounds 2, 3, 4, and 5, respectively). Referring to Table 3, the properties MN, MW, PDI, acid number, CPR, OH number, Water %, and Unsaturation are determined as detailed above.

Formation of Starter Compounds can generally be performed in a batch-wise, semi-batch, semi-continuously, or continuously.

In a batch process, the components (e.g., DMC catalyst, Initiator Compound, alkylene oxide etc.) are charged to a reaction vessel and heated to a temperature until the desired amount of reacted polyol is obtained and then the partially reacted initiator polyol is removed, after which the batch process can be repeated.

In a semi-batch process, the DMC catalyst and Initiator Compound are combined. When the DMC catalyst has become activated (typically as indicated by a drop of internal reactor pressure), an alkylene oxide feed provided, and a reaction is allowed to proceed until the desired amount of reacted Polyol is obtained and then the partially reacted initiator polyol is removed, after which the semi-batch process can be repeated. Additional DMC catalyst may be added during the course of the oxide addition, though in a semi-batch process, the entire amount of Initiator Compound is added at a start of the process.

A semi-continuous process is similar to a semi-batch process but employs a continuous addition of Initiator Compound.

A continuous process includes the continuous addition of at least the DMC catalyst, the oxide(s) such as PO, an Initiator Compound, and employs the continuous removal of product (Starter Compound). A continuous process employs a vessel having one or more inlets through which the alkylene oxide and Starter compound(s) may be introduced during the reaction. In a continuous process, the reactor vessel should contain at least one outlet through which a portion of the partially reacted mixture may be withdrawn. A tubular reactor that has single or multiple points for injecting the starting materials, a loop reactor, and a continuous stirred tank reactor (CSTR) are all suitable types of vessels for continuous processes. An exemplary process is discussed in U.S. Patent Publication No. 2011/0105802.

Working Example 1 is a haze-free polyurethane formulation including a TPG initiator polyol as Starter Compound 1 (i.e., a propoxylated diol having a molecular weight of approximately 1000 gram (g)/mole prepared via a continuous DMC catalysis process, as described herein). In particular, Working Example 1 is prepared using the following continuous method: a reactor is charged and maintained at a steady state with a mixture of components (Initiator Compound 1, an alkylene oxide (propylene oxide), DMC Catalyst, Additive (Phosphoric acid), and Antioxidant present within the ranges listed below in Table 1 to produce the initiator polyol/Starter Compound 1 of Working Example 1. For instance, in Working Example 1, the reactor is charged and maintained at a steady state with the Initiator Compound 1 (18.97 weight percent of a total weight of the mixture), propylene oxide (80.98 weight percent), the DMC catalyst (35 parts per million) to continuously produce a polyol, after which phosphoric acid (10 parts per million) and the antioxidant (500 parts per million) are added to the polyol to continuously produce the polyol/Stater compound 1 of Working Example 1

The Starter Compound 1 is included in the polyurethane formulation of Working Example 1 as detailed in Table 2.

TABLE 1

| | Range (Weight percent | Working |
|---|---|---|
| | unless otherwise listed) | example 1 |
| Initiator compound 1 | 6.3-23.7 | 18.97 |
| Propylene oxide | 76.3-93.7 | 80.98 |
| DMC catalyst (ppm) | 30-40 | 35 |
| Phosphoric acid (ppm) | 8-30 | 10 |
| Antioxidant (ppm) | 100-1000 | 500 |

TABLE 2

| | Weight Percent |
|---|---|
| Isocyanate | 7.8 |
| Polyol (Starter Compound 1 | 41.7 |
| for Working Example 1) | |
| Chain extender (Diethanol | 0.5 |
| amine) | |
| Organic solvent (Ethylacetate) | 50.0 |
| Total weight | 100.0 |

A polyurethane formulation of Working Example 1 is prepared as follows: Add to a vessel the following components: Isocyanate (36.2 g) and 194.2 g of the Starter Compound 1 (i.e., TPG initiator polyol) to form a mixture. Heat the vessel to 80 C.°, agitate/stir while maintaining the vessel temperature at 80 C.° for six hours to obtain an NCO terminated initiator polyol (140.4 g) having about 0.42 isocyanate group (NCO) content. Add the Organic solvent (232.8 g of Ethyl acetate) and the Chain extender (2.4 g) to the vessel to form a reaction mixture. Agitate/Stir the reaction mixture for two hours to obtain a haze-free polyurethane formulation of Working Example 1 having the components included in Table 2 including ˜50% solids (Isocyanate, Initiator polyol, Chain extender) and ˜50% Organic solvent. As mentioned, the haze-free polyurethane formulation of Working Example 1 when cured forms a polyurethane adhesive. That is, as is appreciated by a skilled person, the haze-free polyurethane formulation of Working Example 1 when cured forms aa haze-free polyurethane such as haze-free polyurethane adhesive.

Comparative Example A (i.e., CE. A) is polyurethane formulation including a (MPG) initiator polyol prepared via a continuous DMC catalysis process that is the same as in Working Example 1 but employs Initiator Compound 2 and the resulting Starter Compound 2 (i.e., a propoxylated diol having a molecular weight of approximately 1000 g/mole).

Comparative Example B (i.e., CE. B) is polyurethane formulation including a (DPG) initiator polyol prepared via a continuous DMC catalysis process that is the same as in Working Example 1 but employs Initiator Compound 3 and the resulting Starter Compound 3 (i.e., a propoxylated diol having a molecular weight of approximately 1000 g/mole).

Comparative Example C (i.e., CE. C) is polyurethane formulation including a (MPG) initiator polyol prepared via a semi-batch DMC catalysis process utilizing Initiator Compound 4 that produces an amount of Starter Compound 4 (which is commercially available). A polyurethane formulation of Comparative Example C is prepared as follows: Add to a vessel the following components: Isocyanate (36.2 g) and the 194.2 g of the Starter Compound 4 to form a mixture. Heat the vessel to 80 C.°, agitate/stir the mixture while maintaining the vessel temperature at 80 C.° for six hours to obtain an NCO terminated initiator polyol (240.4 g) having about 0.42 isocyanate group (NCO) content. Add the Organic solvent (232.8 g of Ethyl acetate) and the Chain extender (2.4 g) to the vessel to form a reaction mixture. Agitate/stir the reaction mixture for two hours to obtain a polyurethane formulation of Comparative Example C.

Comparative Example D (i.e., CE. D) is a polyurethane formulation including a (MPG) initiator polyol prepared via a continuous KOH catalysis process that employs Initiator Compound 5 and produces an amount of Starter Compound 5 (which is commercially available). A polyurethane formulation of Comparative Example D is prepared as follows: Add to a vessel the following components: Isocyanate (36.2 g) and the 194.2 g of the Starter Compound 4 to form a mixture. Heat the vessel to 80 C.°, stir while maintaining the vessel temperature at 80 C.° for six hours to obtain an NCO terminated initiator polyol (240.4 g) having about 0.42 isocyanate group (NCO) content. Add the Organic solvent (232.8 of Ethyl acetate) and the Chain extender (2.4 g) to the vessel to form a reaction mixture. Agitate/stir the reaction mixture for two hours to obtain a polyurethane formulation of Comparative Example D.

TABLE 3
(where a value was not tested is indicated as (-))

| | | | | | | Acid | OH | water | |
|---|---|---|---|---|---|---|---|---|---|
| | Process | Visual | MN | MW | PDI | # | number | % | unsaturation |
| WE | Continuous | Clear | 909 | 1051 | 1.1 | 0.013 | 114 | 0.011 | 0.0072 |
| 1 | | | | | | | | | |
| CE | Continuous | Hazy | 919 | 1085 | 1.2 | 0.009 | 110 | 0.012 | 0.0053 |
| A | | | | | | | | | |
| CE | Continuous | Hazy | 921 | 1046 | 1.1 | 0.010 | 111 | 0.008 | 0.0076 |
| B | | | | | | | | | |
| CE | Semi-Batch | Clear | 913 | 963 | 1.05 | 0.005 | 112 | 0.021 | 0.010 |
| C | | | | | | | | | |
| CE | Semi-Batch | Clear | — | — | — | 0.015 | 111 | 0.026 | 0.028 |
| D | | | | | | | | | |

As is illustrated in Table 3, Working Example 1 appears haze-free (clear) upon visual inspection whereas Comparative Example A and Comparative Example B which are also prepared via continuous DMC catalysis appear hazy upon visual inspection. It is further noted that the hazy appearance of the polyurethane formulations of Comparative Examples A and B extends to the resulting cured polyurethanes formed from the polyurethane formulations of Comparative Examples A and B. That is, Working Example 1 desirably and surprisingly provides for the continuous DMC catalysis based production of TPG initiator polyols which result in clear polyurethane formulations and clear cured polyurethanes such as clear polyurethane adhesives.

Notably, the haze-free visual appearance of Working Example 1 was realized while maintaining similar values of other properties (MN, MW, PDI, acid number, OH number, Water %, Unsaturation) as reflected in Table 3. Moreover, the clear visual appearance of Working Example 1 was realized using a Starter Compound 1 which is desirably formed via a continuous process instead of other approaches (Comparative Examples C and D) which need be formed via a batch or semi-batch process to realize a clear visual appearance (as is apparent from Comparative Example A which provides a polyurethane formulation that is hazy and employs a MPG initiator polyol formed via a continuous DMC catalysis). Without being bound to theory, it is believed the haze-free polyurethane formulations are haze-free due at least in part to having reduced or no small molecular weight species present in the polyurethane formulation of Working Example 1, as it is theorized the smaller molecular weight species lead to phase separation in the Organic solvent.

1. A haze-free polyurethane formulation, comprising
a tripropylene glycol (TPG) initiator polyol formed in the presence of a double metal cyanide (DMC) catalyst via a continuous process, wherein the TPG initiator polyol is 30 to 45 percent by weight of the haze-free polyurethane formulation;
an organic solvent present from 30 to 60 percent by weight of the haze-free polyurethane formulation; and
a polyisocyanate, where the polyurethane formulation has an isocyanate index in a range from 70 to 500.

2. The haze-free polyurethane formulation of claim 1, further comprising a chain extender selected from a group consisting of diethanol amine, monoethanol amine, triethanol amine, mono(isopropanol) amine, di(isopropanol) amine, tri(isopropanol) amine, glycerine, trimethylol propane, and pentaerythritol.

3. The haze-free polyurethane formulation of claim 2, wherein a ratio between the TPG initiator polyol and the organic solvent is from 0.5:1.0 to 1.5:1.0 by weight percent of a total weight percent of the haze-free polyurethane formulation.

4. The haze-free polyurethane formulation of claim 1, wherein the polyisocyanate is from 5 to 10 weight percent of a total weight percent of the haze-free polyurethane formulation.

5. The haze-free polyurethane formulation of claim 1, wherein the polyurethane formulation has:
a MN in a range from 800 to 3000;
a MW in a range from 800 to 2200; and
a polydispersity index (PDI) in a range from 1.0 to 1.5.

6. A haze-free polyurethane formed by curing the haze-free polyurethane formulation of claim 1.

7. The haze-free polyurethane of claim 6, wherein the haze-free polyurethane further comprises a haze-free polyurethane adhesive.

8. A method for preparing a haze-free polyurethane formulation, comprising:
admixing a polyisocyanate and a tripropylene glycol (TPG) initiator polyol formed in the presence of a double metal cyanide (DMC) catalyst via a continuous process;
heating and agitating the admixture;
adding an organic solvent and a chain extender to form a reaction mixture; and
agitating the reaction mixture to form a haze-free polyurethane formulation.

9. The method of claim 8, further comprising curing the haze-free polyurethane formulation of claim 8 to form a haze-free polyurethane.
